(19) United States
(12) Patent Application Publication
(10) Pub. No.: US 2019/0260905 A1
(43) Pub. Date: Aug. 22, 2019

(54) IMAGE FORMING APPARATUS AND IMAGE FORMING METHOD

(71) Applicant: Toshiba Tec Kabushiki Kaisha, Tokyo (JP)

(72) Inventor: Fusayoshi Takezawa, Tokyo (JP)

(21) Appl. No.: 16/244,973

(22) Filed: Jan. 10, 2019

(30) Foreign Application Priority Data
Feb. 20, 2018 (JP) 2018-028156

(51) Int. Cl. H04N 1/32

(52) U.S. Cl. CPC H04N 1/32128; H04N 1/32363; H04N 2201/3202; H04N 2201/3277; H04N 2201/3212; H04N 2201/3226; H04N 2201/3273; H04N 2201/3205

(57) ABSTRACT

According to an embodiment, an image forming apparatus includes a communication device, a storage device, a display, a printer, and a processor. The communication device receives a document from a different apparatus. The processor causes the display to display, on the basis of the received documents stored in the storage device, a list of the received documents in an unprinted state, which are not yet printed by the printer, by distinguishing between the received document in an unread state that is not yet displayed by the display and the received document in an already-read state that is already displayed by the display.

### CROSS-REFERENCE TO RELATED APPLICATIONS

This application is based upon and claims the benefit of priority from the prior Japanese Patent Application No. 2018-028156, filed on Feb. 20, 2018, the entire contents of which are incorporated herein by reference.

### FIELD

An embodiment to be described here generally relates to an image forming apparatus and an image forming method.

### BACKGROUND

Image forming apparatuses such as multifunctional machines receive facsimile documents in some cases. A user can read a facsimile document previewed on a display of the image forming apparatus. The user may merely read the previewed facsimile document and may not print that facsimile document by the image forming apparatus. A memory of the image forming apparatus stores the facsimile documents irrespective of whether the facsimile documents are unread or not. If the facsimile documents stored in the memory are not previewed on the display again, the user has difficulty in distinguishing between facsimile documents that are unread and unprinted and facsimile documents that are already read and unprinted. However, the image forming apparatuses in the related art have not been capable of distinguishing, for display, between facsimile documents that are unread and unprinted and facsimile documents that are already read and unprinted in some cases.

### BRIEF DESCRIPTION OF THE DRAWINGS

FIG. 1 is an outer appearance view of the entire configuration example of an image forming apparatus according to an embodiment.

FIG. 2 is a block diagram showing a hardware configuration example of the image forming apparatus according to the embodiment.

FIG. 3 is a diagram showing an example of a data table according to the embodiment.

FIG. 4 is a diagram showing an example of a light-emitting device according to the embodiment.

FIG. 5 is a diagram showing a display example of a list of facsimile documents according to the embodiment.

FIG. 6 is a diagram showing an example of facsimile documents previewed in a thumbnail form according to the embodiment.

FIG. 7 is a diagram showing an example of facsimile documents whose images are previewed in an enlarged form as compared to thumbnail images according to the embodiment.

FIG. 8 is a flowchart showing an operation example of the image forming apparatus according to the embodiment.

### DETAILED DESCRIPTION

According to one embodiment, an image forming apparatus includes a communication device, a storage device, a display, a printer, and a processor. The communication device receives a document from a different apparatus. The storage device stores the received document received by the communication device. The display displays the stored received document. The printer prints the stored received document. The processor causes the display to display, on the basis of the received documents stored in the storage device, a list of the received documents in an unprinted state, which are not yet printed by the printer, by distinguishing between the received document in an unread state that is not yet displayed by the display and the received document in an already-read state that is already displayed by the display.

Hereinafter, an image forming apparatus and an image forming method according to an embodiment will be described with reference to the drawings. In the drawings, the same reference symbols represent the same or similar units.

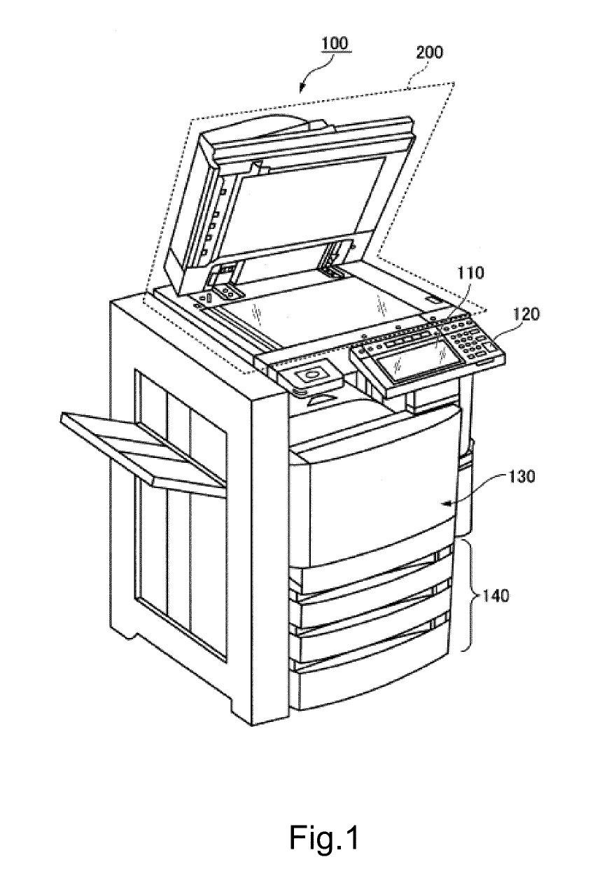

FIG. 1 is an outer appearance view of the entire configuration example of an image forming apparatus 100 according to an embodiment. The image forming apparatus 100 is, for example, a multifunctional machine. The image forming apparatus 100 includes a display 110, a control panel 120, a printer 130, a sheet housing device 140, and an image reading device 200. Note that the printer 130 of the image forming apparatus 100 may be an electrophotographic apparatus or an ink-jet apparatus.

The image forming apparatus 100 uses a developer including a toner or the like to form an image on a sheet. The sheet is, for example, paper or label paper. The sheet only needs to be a medium on which the image forming apparatus 100 is capable of forming images on the surface thereof.

The display 110 is an image display device such as a liquid crystal display or an organic electro luminescence (EL) display. The display 110 displays various types of information regarding the image forming apparatus 100.

The control panel 120 includes a plurality of buttons. The control panel 120 receives an operation of a user. The control panel 120 outputs a signal corresponding to an operation performed by the user to a controller of the image forming apparatus 100. Note that the display 110 and the control panel 120 may be configured as an integrated touch panel.

The printer 130 forms an image on a sheet on the basis of image information generated by the image reading device 200 or image information received via a communication path. The printer 130 forms an image by, for example, processing to be described below. The printer 130 includes an image forming device (not shown). The image forming device of the printer 130 forms an electrostatic latent image on a photosensitive drum on the basis of the image information. The image forming device of the printer 130 causes a toner of the developer to adhere to the electrostatic latent image to form a visible image (toner image). The printer 130 includes a transfer device (not shown). The transfer device of the printer 130 transfers the toner image (visible image) to the sheet. The printer 130 includes a fixing device (not shown). The fixing device of the printer 130 heats and presses the sheet to fix the toner image on the sheet. Note that the sheet on which an image is to be formed may be a sheet housed in the sheet housing device 140 or may be a sheet that is manually fed to a manual feeding device (not shown).

The sheet housing device 140 houses sheets to be used for image formation in the printer 130.

The image reading device 200 reads image information to be read, as brightness and darkness of light. The image reading device 200 records the read image information. The recorded image information may be transmitted to another information processing apparatus via a network. The recorded image information may be used to form an image on a sheet by the printer 130.

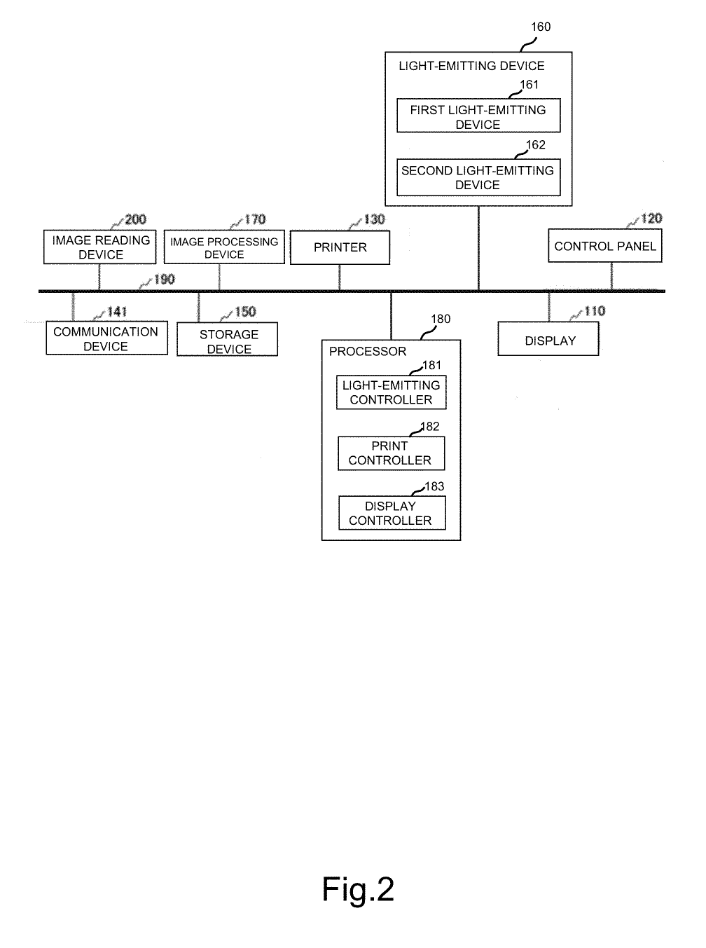

FIG. 2 is a block diagram showing a hardware configuration example of the image forming apparatus 100. The image forming apparatus 100 includes a communication device 141, a storage device 150, a light-emitting device 160, an image processing device 170, a processor 180, and a bus 190. The bus 190 transfers data between the functional devices of the image forming apparatus 100.

The communication device 141 receives document data from a different apparatus via a communication path. The different apparatus is, for example, a facsimile apparatus. In the following description, a document received by the communication device 141 is referred to as a “facsimile document”. The communication device 141 records the facsimile document in the storage device 150 via the bus 190.

The storage device 150 includes a non-volatile storage medium (non-temporal storage medium) such as a flash memory or a hard disk drive (HDD). The storage device 150 stores, when the communication device 141 receives a facsimile document, the received facsimile document in a predetermined data format. The storage device 150 further stores a program to be executed by the processor 180 and various types of setting information. Note that the storage device 150 may further include a random access memory (RAM).

The storage device 150 stores the facsimile document in association with identification information. For example, the identification information is a specific number such as “01” or “02”. The storage device 150 deletes a facsimile document printed by the printer 130 from the storage device 150 in response to an instruction from the processor 180. The storage device 150 stores a facsimile document in an unprinted state (hereinafter, referred to as “unprinted facsimile document” in some cases) as a facsimile document that is stored without being deleted because of an unprinted state thereof. Note that a facsimile document to be printed by the printer 130 is selected through, for example, the control panel 120.

The processor 180 selects an unprinted facsimile document to be displayed in response to an operation received through the control panel 120. The unprinted facsimile document selected by the processor 180 is previewed on the display 110. The previewed facsimile document is a facsimile document in an already-read and unprinted state. A facsimile document that is not previewed is a facsimile document in an unread and unprinted state. The storage device 150 stores a data table including the identification information.

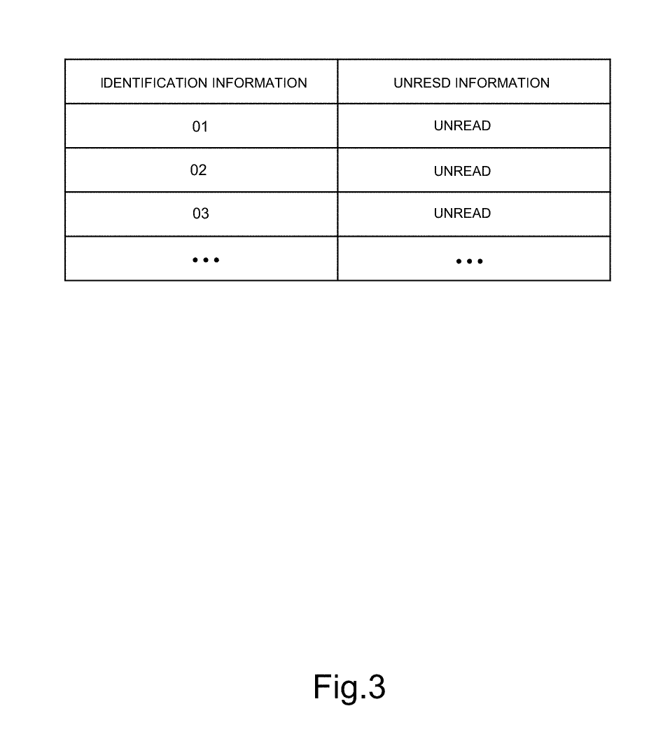

FIG. 3 is a diagram showing an example of the data table. In the data table, the identification information of a facsimile document in an unprinted state and the unread information indicating information in an unread state are associated with each other. The unread information may be flag information indicating an unread state or an already-read state. The storage device 150 stores an unprinted facsimile document, the identification information, and the unread information in association with one another by using the data table. The processor 180 associates, for example, when the communication device 141 receives a facsimile document, the facsimile document (unprinted facsimile document), the identification information, and the unread information with one another by using the data table and causes the storage device 150 to store them.

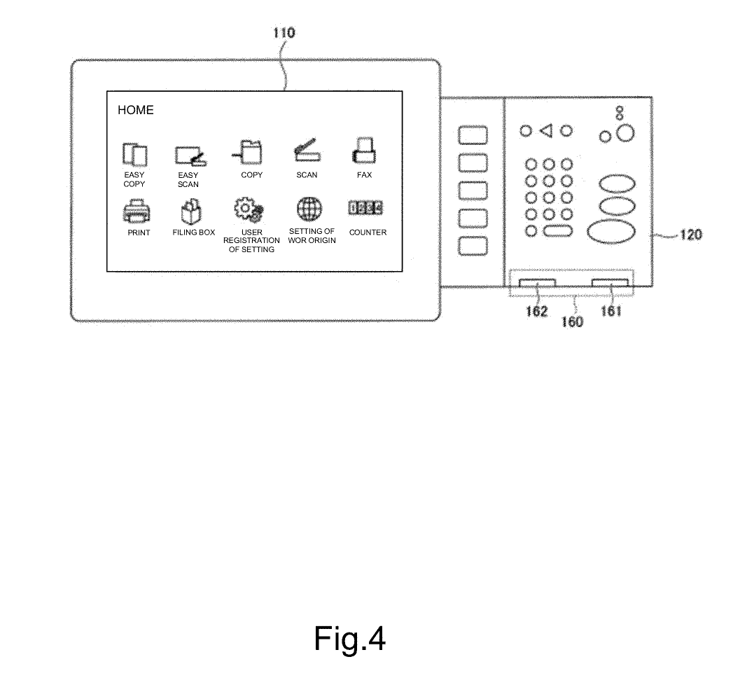

FIG. 4 is a diagram showing an example of the light-emitting device 160. The user can visually recognize the light-emitting device 160 provided to the control panel 120. The light-emitting device 160 includes a light-emitting device such as a light emitting diode (LED). In FIG. 4, the light-emitting device 160 includes a first light-emitting device 161 and a second light-emitting device 162.

Irrespective of whether an unprinted facsimile document is associated with the unread information or not, when the unprinted facsimile document is stored in the storage device 150, the first light-emitting device 161 lights up. When a facsimile document in an unread and unprinted state is stored in the storage device 150, the second light-emitting device 162 lights up. In other words, when an unprinted facsimile document associated with the unread information is stored in the storage device 150, the second light-emitting device 162 lights up.

Note that the first light-emitting device 161 may display the number of facsimile documents that are in an unprinted state and are stored in the storage device 150. The second light-emitting device 162 may display the number of facsimile documents that are in an unread and unprinted state and are stored in the storage device 150.

The image processing device 170 executes image processing under the control of a display controller 183. For example, the image processing device 170 performs image processing on a facsimile document in an unprinted state to thereby generate an image of the facsimile document for preview.

When the facsimile document in the unread and unprinted state is previewed, the processor 180 deletes the unread information associated with the identification information of that facsimile document from the data table.

The processor 180 is a central processing unit (CPU) or the like. The processor 180 executes a program stored in the storage device 150. Part of the processing to be executed by the processor 180 may be achieved by using hardware such as a large scale integration (LSI) or an application specific integrated circuit (ASIC).

The processor 180 includes a light-emission controller 181, a print controller 182, and the display controller 183. When the communication device 141 receives a facsimile document, the light-emission controller 181 turns on the first light-emitting device 161 and the second light-emitting device 162. In other words, when an unprinted facsimile document is stored in the storage device 150, the light-emission controller 181 turns on the first light-emitting device 161.

When an unprinted facsimile document is not stored in the storage device 150, the light-emission controller 181 turns off the first light-emitting device 161. Note that the light-emission controller 181 may blink the first light-emitting device 161 when the communication device 141 receives document data to be printed from a different apparatus.

When any of the unprinted facsimile documents stored in the storage device 150 is in the unread state, the light-emission controller 181 turns on the second light-emitting device 162. In other words, when the facsimile document in the unread and unprinted state is stored in the storage device 150, the light-emission controller 181 turns on the second light-emitting device 162.

When all of the unprinted facsimile documents stored in the storage device 150 are in the already-read state, the light-emission controller 181 turns off the second light-emitting device 162. In other words, when the facsimile documents in the unread and unprinted state are not stored in the storage device 150, the light-emission controller 181 turns off the second light-emitting device 162.

When a print button 300 is pressed for operation, the print controller 182 uses the printer 130 to print the unprinted facsimile document. When the print button 300 is pressed for operation, the print controller 182 deletes the data of the selected unprinted facsimile document from the storage device 150. The print controller 182 deletes from the data table the identification information and the unread information of the deleted unprinted facsimile document.

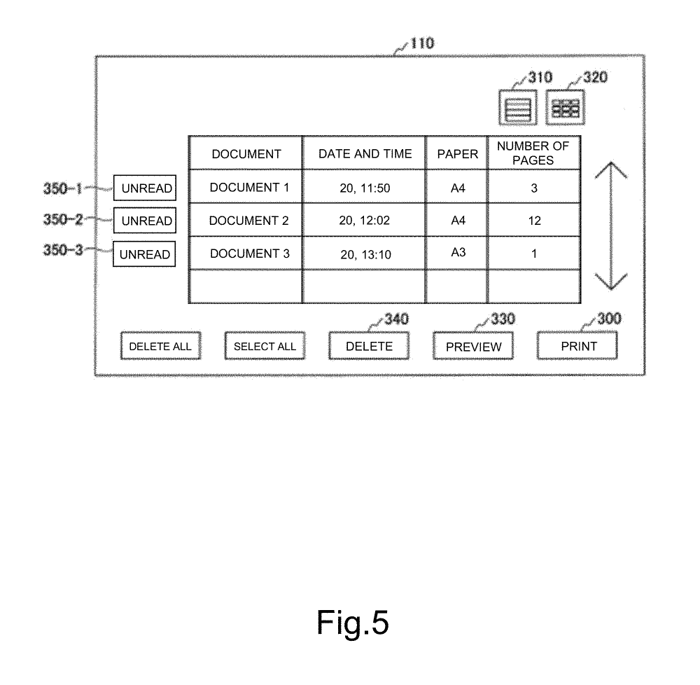

FIG. 5 is a diagram showing a display example of a list of facsimile documents. When a list display button 310 is pressed for operation, the display controller 183 displays a list of attribute information of the facsimile documents on the display 110. For example, the attribute information includes the identification information, reception date and time, a paper size, and the number of pages. Unread icons 350 are icon images each representing a facsimile document of the identification information with which the unread information is associated. In other words, the unread icon 350 is an icon image representing a facsimile document in an unread and unprinted state. The display controller 183 displays the attribute information of the facsimile documents in the unread and unprinted state and the unread icons 350 in association with each other on the display 110.

When a tile display button 320 is pressed for operation, the display controller 183 displays a list of the icon images of the facsimile documents in a tile form on the display 110. The icon image of the facsimile document may be a predetermined image or a thumbnail image of the facsimile document.

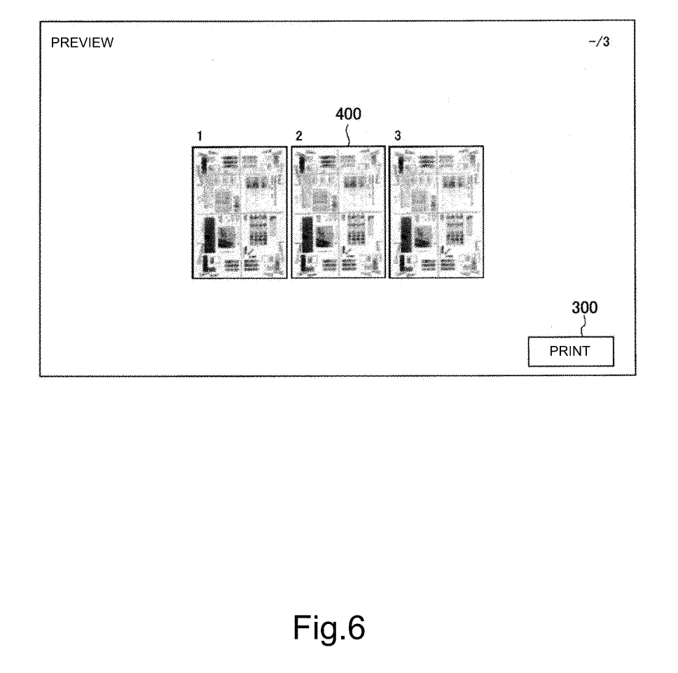

FIG. 6 is a diagram showing an example of the facsimile documents previewed in a thumbnail form. When a preview display button 330 is pressed for operation, the display controller 183 displays the preview of unprinted facsimile documents for each page in a thumbnail form on the display 110.

When the facsimile document in the unread and unprinted state is previewed, the display controller 183 deletes the unread information associated with the identification information of that facsimile document from the data table shown in FIG. 3.

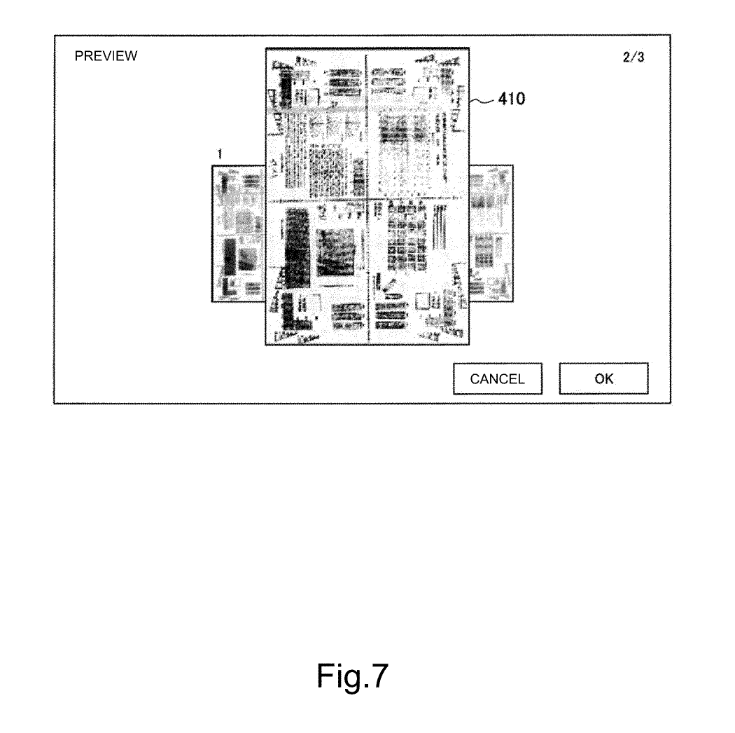

FIG. 7 is a diagram showing an example of facsimile documents whose images are previewed in an enlarged form as compared to thumbnail images (hereinafter, referred to as “enlarged form”). When a specific page of the facsimile documents previewed in a thumbnail form is selected, the display controller 183 enlarges an image of the selected specific page of the facsimile documents on the display 110.

An administrator or the user operates the control panel 120 and can thus change the setting information stored in the storage device 150. For example, the display controller 183 acquires, from the storage device 150, the setting information for which conditions for deleting the unread information from the data table are determined. For example, the setting information indicates the thumbnail form, the enlarged form, the top page, all pages, an administrator account or a user account, and the like. In order to satisfy the conditions indicated by the setting information, the display controller 183 deletes, when an unprinted facsimile document is displayed, the unread information associated with the identification information of the displayed unprinted facsimile document from the data table.

When the setting information indicates the thumbnail form and when a facsimile document is previewed in the thumbnail form as shown in FIG. 6, the display controller 183 deletes the unread information associated with the identification information of that facsimile document from the data table.

When the setting information indicates the enlarged form and when a facsimile document is previewed in the enlarged form as shown in FIG. 7, the display controller 183 deletes the unread information associated with the identification information of that facsimile document from the data table.

When the setting information indicates the top page and when the top page of a facsimile document is previewed, the display controller 183 deletes the unread information associated with the identification information of that facsimile document from the data table.

When the setting information indicates the all pages and when the all pages of a facsimile document are previewed, the display controller 183 deletes the unread information associated with the identification information of that facsimile document from the data table.

When the setting information indicates the administrator account and when a facsimile document is previewed by an operation of the administrator, the display controller 183 deletes the unread information associated with the identification information of that facsimile document from the data table.

When the setting information indicates the user account and when a facsimile document addressed to that user is previewed by an operation of the user, the display controller 183 deletes the unread information associated with the identification information of that facsimile document from the data table.

Note that the display controller 183 may register the unread information deleted from the data table again in the data table in response to an operation received through the control panel 120. This allows the display 110 to display again the deleted unread icons 350.

The display controller 183 may display a message on the display 110 in a pop-up manner on the basis of predetermined conditions. For example, the message includes a message to give notice of the number of facsimile documents in the unprinted state and a message to give notice of the number of facsimile documents in the unread and unprinted state. The message may be a message to guide an operation to be performed by the user. The message may be a message indicating that a facsimile document in the already-read and unprinted state is stored in the storage device 150 for a certain period of time or longer.

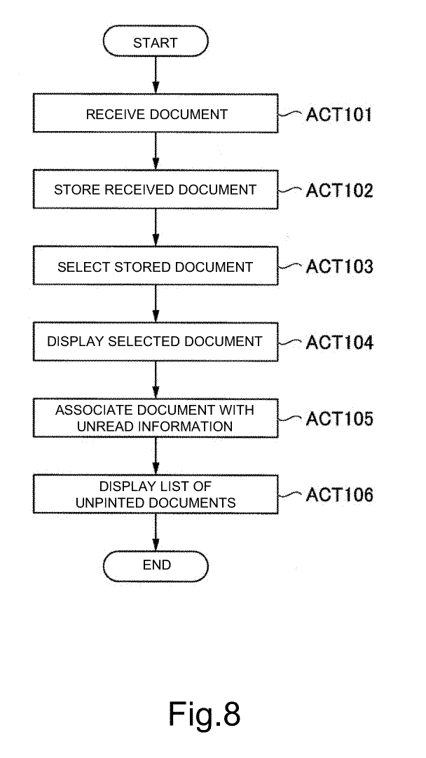

Next, an operation example of the image forming apparatus 100 will be described. FIG. 8 is a flowchart showing an operation example of the image forming apparatus 100. In ACT101, the communication device 141 receives a facsimile document. In ACT102, the storage device 150 stores the received facsimile document. Specifically, for example, the processor 180 associates the received facsimile document (unprinted facsimile document), identification information, and unread information with one another by using the data table to cause the storage device 150 to store them. In ACT103, the control panel 120 receives an operation of selecting an unprinted facsimile document to be displayed from among the unprinted facsimile documents stored without being deleted.

In ACT104, the display 110 previews the selected unprinted facsimile document. In other words, the processor 180 causes the display 110 to display the selected unprinted facsimile document. In ACT105, the storage device 150 stores an unprinted facsimile document, which is not yet displayed, and unread information in association with each other. Specifically, for example, the processor 180 deletes the unread information associated with the unprinted facsimile document, which is already displayed, from the storage device 150. The processor 180 then keeps the association between the unprinted facsimile document, which is not displayed, and the unread information. In ACT106, the display controller 183 of the processor 180 distinguishes between the facsimile documents in the unread and unprinted state and the facsimile documents in the already-read and unprinted state and causes the display 110 to display a list of the unprinted facsimile documents.

As described above, in the image forming apparatus 100, the communication device 141 receives the facsimile document, and the storage device 150 (document storing unit) stores the facsimile document. The control panel 120 receives an operation of selecting an unprinted facsimile document to be displayed from among the unprinted facsimile documents stored without being deleted. The display 110 displays the selected unprinted facsimile document. The displayed unprinted facsimile document becomes a facsimile document in an already-read and unprinted state. The storage device 150 (unread information storing unit) stores the unprinted facsimile document, which is not displayed, and the unread information in association with each other. The display controller 183 distinguishes between the facsimile documents in the unread and unprinted state and the facsimile documents in the already-read and unprinted state and causes the display 110 to display a list of the unprinted facsimile documents.

According to at least one embodiment described above, the image forming apparatus 100 includes the display controller 183 and can thus distinguish between the facsimile documents in the unread and unprinted state and the facsimile documents in the already-read and unprinted state for display.

The functions of the image forming apparatus in the embodiment described above may be achieved by a computer. In such a case, the functions of the image forming apparatus may be achieved by recording a program for achieving those functions in a computer-readable recording medium, and causing a computer system to read and execute the program stored in that recording medium. Note that the “computer system” herein includes the OS and hardware such as peripherals. Further, the “computer-readable recording medium” means a portable medium such as a flexible disk, a magneto-optical disk, a ROM, or a CDROM, or a storage device such as a hard disk incorporated into the computer system. Furthermore, the “computer-readable recording medium” may include a medium that dynamically holds a program for a short period of time like a network such as the Internet or communication wires used when a program is transmitted via a communication line such as a telephone line, or may include a medium that holds a program for a certain period of time like a volatile memory inside a computer system, which is to be a server or a client in the former case. Further, the program described above may be a program for achieving part of the above-mentioned functions. Furthermore, the program described above may be a program capable of achieving the above-mentioned functions in combination with programs already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a communication device that receives a document from a different apparatus;
a storage device that stores the received document received by the communication device;
a display that displays the stored received document;
a printer that prints the stored received document; and
a processor that causes the display to display, on a basis of the received documents stored in the storage device, a list of the received documents in an unprinted state, in which the received documents have not yet been printed by the printer, by distinguishing between the received documents that are in an unread state, in which the received documents have not yet been displayed by the display, and the received documents in an already-read state, in which the received documents have already been displayed by the display.

2. The image forming apparatus according to claim 1, wherein the processor:
associates, when the communication device receives a document from the different apparatus, first information indicating the unread state with the received document and causes the storage device to store the received document, and
deletes, when the received document stored in the storage device is displayed by the display, the first information associated with the displayed received document from the storage device.

3. The image forming apparatus according to claim 2, wherein the processor deletes the received document printed by the printer from the storage device.

4. The image forming apparatus according to claim 3, further comprising:
a control panel that receives a selection of the received document to be displayed on the display from among the received documents stored in the storage device, wherein
the processor causes, when the control panel receives the selection of the received document to be displayed, the display to display the received document to be displayed.

5. The image forming apparatus according to claim 4, wherein the processor deletes, when the control panel receives the selection of the received document to be displayed, the first information associated with the received document to be displayed from the storage device.

6. The image forming apparatus according to claim 3, wherein the processor causes the display to display the received documents stored in the storage device as a list of the received documents in the unprinted state, by distinguishing between the received documents stored in the storage device and associated with the first information and the received documents stored in the storage device and not associated with the first information.

7. The image forming apparatus according to claim 2, further comprising:
a light-emitting device that lights up when the received document with which the first information is associated is stored in the storage device.

8. The image forming apparatus according to claim 7, further comprising:
a different light-emitting device that lights up when the received document is stored in the storage device irrespective of whether the first information is associated with the received document or not.

9. The image forming apparatus according to claim 2, wherein the processor deletes, when the received document is displayed by the display to satisfy a predetermined condition, the first information associated with the displayed received document from the storage device.

10. An image forming method, comprising:
receiving, via a communication device of an image forming apparatus, a document from a different apparatus;
storing the received document in a storage device of the image forming apparatus in association with first information indicating that the received document is in an unread state as not yet displayed by a display of the image forming apparatus;
receiving, via a control panel of the image forming apparatus, a selection of the received document to be displayed on the display from among received documents stored in the storage device;
displaying the selected received document on the display;
deleting the first information associated with the displayed received document from the storage device; and
causing the display to display, on a basis of the received documents stored in the storage device, a list of received documents in an unprinted state, which is a state in which the received documents have not yet been printed by a printer of the image forming apparatus, by distinguishing between the received documents with which the first information is associated and the received documents with which the first information is not associated.
